(19) United States
(12) Patent Application Publication
(10) Pub. No.: US 2021/0207015 A1
(43) Pub. Date: Jul. 8, 2021

(54) REFRIGERATION PACK PRODUCT AND METHOD FOR PROVIDING SAME COMPRISING PROVIDING A SLURRY INCLUDING A THICKENING AGENT

(71) Applicant: Mordechai Einhorn, Toronto (CA)

(72) Inventor: Mordechai Einhorn, Toronto (CA)

(21) Appl. No.: 17/141,724

(22) Filed: Jan. 5, 2021

Related U.S. Application Data
(60) Provisional application No. 62/957,663, filed on Jan. 6, 2020.

(51) Int. Cl. C09K 5/06; B65D 81/18; B65B 1/04; F25D 3/00

(52) U.S. Cl. CPC C09K 5/066; F25D 3/00; B65B 1/04; B65D 81/18

(57) ABSTRACT

Described herein is a refrigeration pack and a method of providing same, comprising: providing a pumpable slurry comprising a frozen component and a liquid component, providing within the pumpable slurry a thickening agent to absorb some of the liquid component of the pumpable slurry, and to increase a viscosity of the pumpable slurry; providing a refrigeration pack housing; and, providing the pumpable slurry to the refrigeration pack housing.

### CROSS-REFERENCE TO RELATED APPLICATION

This application claims the benefit of U.S. Provisional Patent Application No. 62/957,663, filed Jan. 6, 2020, the contents of which are incorporated herein by reference.

### FIELD

The described embodiments relate to the field of refrigeration, in particular, the field of refrigeration packs and methods of using refrigeration packs to provide cooling to an interior of a container.

### BACKGROUND

Refrigeration packs are widely used in the food industry for keeping food items such as meat, beverages, and produce cool during, for example, storage or transport. Food items may need to be kept cold during storage or transport to keep them from spoiling.

### SUMMARY

This summary is intended to introduce the reader to various aspects of the applicant's teaching, but not to define any specific embodiments. In general, disclosed herein are one or more methods and products for proving cooling to an interior of a container.

In a first aspect, some embodiments of the invention provide a method of making a refrigeration pack, the method comprising (a) providing a pumpable slurry comprising a frozen component and a liquid component; (b) providing within the pumpable slurry a thickening agent to absorb some of the liquid component of the pumpable slurry, and to increase a viscosity of the pumpable slurry; (c) providing a refrigeration pack housing; and, (d) providing the pumpable slurry to the refrigeration pack housing.

In some embodiments, the refrigeration pack housing is flexible, such that the refrigeration pack comprising the pumpable slurry, the thickening agent and the refrigeration pack housing is flexible.

In some embodiments, the method includes providing the refrigeration pack to an insulated storage container without freezing the pumpable slurry and the thickening agent within the refrigeration pack housing.

In some embodiments, the method includes providing a freeze suppressant within the pumpable slurry to reduce the freezing temperature of the pumpable slurry below 0° C.

In some embodiments, the freeze suppressant comprises at least one of ethylene glycol or propylene glycol.

In some embodiments, the thickening agent is one of a polymer, cornstarch or gelatin.

In some embodiments, the thickening agent is a polymer.

In some embodiments, the polymer is a super absorbent polymer.

In some embodiments, the method includes freezing the pumpable slurry within the refrigeration pack housing.

In some embodiments, providing the thickening agent within the pumpable slurry comprises first providing the frozen component and the liquid component, and then adding the thickening agent to at least the liquid component of the pumpable slurry.

In some embodiments, the frozen component is ice and the liquid component is water, and providing the frozen component and the liquid component comprises cooling water to its freezing temperature.

In some embodiments, wherein even when the frozen component is entirely melted, the viscosity of the pumpable slurry is a minimum of 20,000 cP.

In some embodiments, providing the thickening agent within the pumpable slurry comprises providing the thickening agent to the refrigeration pack housing.

In some embodiments, a weight of the liquid component of at least 30 times the weight of the thickening agent is absorbable by the thickening agent.

In some embodiments, the method includes providing a plurality of refrigeration packs, the method further comprising transporting the plurality of refrigeration packs to a customer, and, while transporting the plurality of refrigeration packs to the customer, maintaining as frozen at least some of the frozen component of the pumpable slurry within each refrigeration pack in the plurality of refrigeration packs.

In another aspect of the invention, provided is a refrigeration pack, comprising a refrigeration pack housing defining an internal volume divisible into a core portion, comprising ⅓ of the internal volume, a peripheral portion comprising ⅓ of the internal volume, and an intermediate portion between the core and peripheral portions comprising ⅓ of the internal volume. The refrigeration pack further comprises a pumpable slurry within the refrigeration pack housing, wherein the pumpable slurry comprises a frozen component and a liquid component; the pumpable slurry has a core ratio of the frozen component to the liquid component within the core portion; the pumpable slurry has an intermediate ratio of the frozen component to the liquid component within the intermediate portion; the pumpable slurry has a peripheral ratio of the frozen component to the liquid component within the peripheral portion; and, the core ratio, the intermediate ratio and the peripheral ratio are substantially the same.

In some embodiments, the refrigeration pack further comprises a thickening agent for absorbing some of the liquid component of the slurry to increase the viscosity of the slurry.

In some embodiments, the thickening agent is a polymer.

In some embodiments, the polymer is a super absorbent polymer.

In some embodiments, a weight of the liquid component of at least 30 times the weight of the thickening agent is absorbable by the thickening agent.

In some embodiments, the internal volume of the refrigeration pack housing has an average ratio of the frozen component to the liquid component; and, the core ratio, the intermediate ratio and the peripheral ratio are each within 5% of the average ratio of the frozen component to the liquid component.

In some embodiments, the internal volume of the refrigeration pack housing has an average ratio of the frozen component to the liquid component; and, the core ratio, the intermediate ratio and the peripheral ratio are each within 2% of the average ratio of the frozen component to the liquid component.

In some embodiments, the internal volume, and a combination of the core portion, intermediate portion and peripheral portion are divisible into an innermost first portion comprising ⅕ of the internal volume, a second portion adjacent the innermost first portion comprising ⅕ of the internal volume, a third portion adjacent the second portion comprising ⅕ of the internal volume, a fourth portion adjacent the third portion comprising ⅕ of the internal volume, and an outermost fifth portion adjacent the fourth portion comprising ⅕ of the internal volume; the pumpable slurry has a first ratio of the frozen component to the liquid component within the innermost first portion; the pumpable slurry has a second ratio of the frozen component to the liquid component within the second portion; the pumpable slurry has a third ratio of the frozen component to the liquid component within the third portion; the pumpable slurry has a fourth ratio of the frozen component to the liquid component within the fourth portion; the pumpable slurry has a fifth ratio of the frozen component to the liquid component within the outermost fifth portion; the internal volume of the refrigeration pack housing has an average ratio of the frozen component to the liquid component; and, the first ratio, the second ratio, the third ratio, the fourth operation and the fifth ratio are each within 5% of the average ratio of the frozen component to the liquid component.

### BRIEF DESCRIPTION OF THE DRAWINGS

The drawings included herewith are for illustrating various examples of articles and apparatuses of the present specification. In the drawings:

FIG. 1, in a flow chart, illustrates a method for providing a refrigerant pack.

FIG. 2, in a flow chart, illustrates an alternative method for providing a refrigerant pack.

FIG. 3, in a flow chart, illustrates an alternative method for providing a refrigerant pack.

FIG. 4, in a flow chart, illustrates an alternative method for providing a plurality of refrigeration packs.

FIG. 5 illustrates a perspective view of a refrigeration pack.

FIG. 6 illustrates a transparent perspective view of the refrigeration pack of FIG. 5.

FIG. 7 illustrates a profile view of a cross section of the refrigeration pack of FIGS. 5-6, along section A-A.

FIG. 8 illustrates a plan view of a cross section of the refrigeration pack of FIGS. 5-7, along section B-B.

FIG. 9 illustrates an alternate profile view of a cross section of the refrigeration pack of FIGS. 5-8, along section A-A.

FIG. 10 illustrates an alternate plan view of a cross section of the refrigeration pack of FIGS. 5-8, along section B-B.

### DESCRIPTION OF EXEMPLARY EMBODIMENTS

It will be appreciated that numerous specific details are set forth to provide a thorough understanding of the example embodiments described herein. However, it will be understood by those of ordinary skill in the art that the embodiments described herein may be practiced without these specific details. In other instances, well-known methods, procedures, and components have not been described in detail so as not to obscure the embodiments described herein. Furthermore, this description and the drawings are not to be considered as limiting the scope of the embodiments described herein in any way, but rather as merely describing the implementation of the various embodiments described herein.

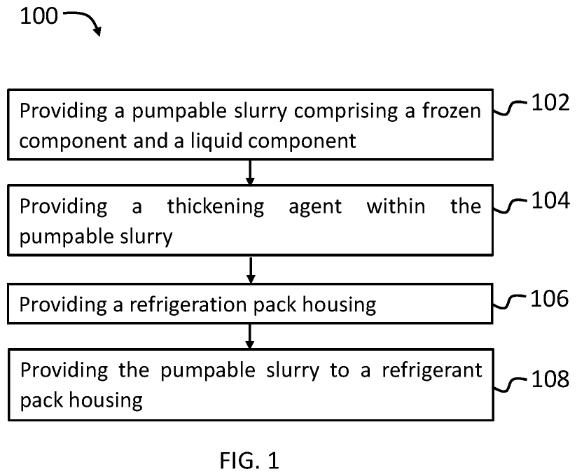

Reference is first made to FIG. 1, in which a method 100 for providing a refrigeration pack is shown. Method 100 may begin at step 102, in which a pumpable slurry comprising a frozen component and a liquid component is provided. A pumpable slurry may be considered to be pumpable if it can be drawn through a conduit, by, for example, suction provided via a conventional pump used in the food processing industry.

In some examples, the pumpable slurry may be a mixture of frozen ice and liquid water, wherein providing the frozen component and the liquid component comprises cooling water to its freezing temperature. In other examples, materials other than water may be used, and combinations of frozen solid and liquid forms of this material may make up the pumpable slurry. This pumpable slurry can be provided by cooling the liquid form of that material to its freezing temperature.

In some examples, the pumpable slurry may be a feed of pumpable slurry from a slurry ice generator. The slurry ice generator may receive a feed of liquid, for example, a feed of water from a water supply such as a tap, and convert the feed of liquid into a feed of pumpable slurry. In other examples, the feed of a liquid may be a feed of a solution from a vat or container. A solution may be a combination of multiple liquids, chemicals, for example, refrigerants and freeze point suppressant additives, and/or other solutes.

Different slurry making machines known in the art may be used to convert the feed of a liquid to the slurry feed. For example, Ice Generator IG-48-10-120 available from IceGen Corp. at 145 Shields Court, Toronto, Ontario, L3R 9T5 Canada may be used to cool the feed to produce a slurry feed. Other slurry making machines, such as the machine described, for example, in U.S. Pat. No. 5,157,939 (Lyon et al.) or U.S. Pat. No. 7,788,943 (Mogilevsky) could also be used.

Still referring to FIG. 1, at step 104, a thickening agent may be provided within the pumpable slurry. When added to the slurry, the thickening agent may increase the viscosity of the pumpable slurry. In some examples, the thickening agent may increase the viscosity of the pumpable slurry by sorbing a portion of the liquid component of the pumpable slurry. In some examples of method 100, the pumpable slurry may be provided, then the thickening agent may be added to at least the liquid component of the pumpable slurry, such that the thickening agent is present largely only in the liquid component of the pumpable slurry. In other examples of method 100, the thickening agent may be provided to a fluid before it is converted to a pumpable slurry, such that the concentration of the thickening agent in the liquid component is substantially equal to the concentration of the thickening agent in the frozen component. In some examples of method 100, the thickening agent may be cornstarch. In other examples of method 100, the thickening agent may be gelatin.

In some examples of method 100, the thickening agent may be a polymer. When added to the pumpable slurry, the polymer may absorb some of the liquid component of the pumpable slurry and may thereby increase a viscosity of the pumpable slurry. In some examples of the method 100, the polymer may be an anionic water-soluble cellulosic polymer. An anionic water-soluble cellulosic polymer may provide a viscosity of 60000 cP. In some examples, highly viscous solutions in the liquid component may be produced by the addition of anionic water-soluble cellulosic polymer, salts, glycols, and optionally alcohols for frost protection. These polymers, salts, glycols and/or alcohols may, in combination, total up to or even exceed 50% of the total weight (most of the remaining weight being water and ice), depending on the desired viscosity. Cellulosic polymers may be used in method 100 as they may be non-toxic, food contact approved and may have a green profile for medical and food-related uses. If necessary, in some examples, at least one of ethylene glycol, propylene glycol or salts like aluminum sulfates, calcium chloride, sodium chloride and small amounts of a water soluble organic dye may also be added to the pumpable slurry. In some examples of method 100, the polymer may be at least one of WALOCEL™ CRT and METHOCEL™, which are available from Dupont. In other examples of method 100, the polymer may be WALOCEL™ CRT 60000 GA, which is a high viscosity sodium carboxymethyl cellulose also available from Dupont. In yet another example of method 100, the polymer may be sodium polyacrylate. Sodium polyacrylate may be used as a thickening agent due to its ability to absorb and hold onto water molecules. In some examples, wherein the added polymer is sodium polyacrylate, the sodium polyacrylate may be 2% by weight of the sodium polyacrylate and water solution, and the water may be 98% by weight of the sodium polyacrylate and water solution. In some examples of method 100, the polymer may be a super absorbent polymer. For example, in some examples of method 100 the super absorbent polymer may be Chempoint TRO C. In some examples, the thickening agent may absorb many times its weight of the liquid component of the pumpable slurry. In some examples, the thickening agent may absorb at least 30 times the weight of the thickening agent of the liquid component of the pumpable slurry. In some examples, the thickening agent may absorb at least 50 times or even 300 times the weight of the thickening agent of the liquid component of the pumpable slurry.

The addition of the thickening agent may increase viscosity even when the frozen component is entirely melted. In this melted state without the thickening agent, viscosity might otherwise be much reduced (viscosity will typically be increased by the presence of the solid component in the pumpable slurry). However, adding the thickening agent can maintain viscosity even in this melted state. In some examples, when the frozen component of the pumpable slurry is entirely melted, the viscosity of the pumpable slurry is a minimum of 20000 cP. In some examples, the viscosity the pumpable slurry within the refrigeration pack ranges between 20,000 to 60,000 cP, and may have an average viscosity of 30,000 cP when the thickening agent, the super absorbent polymer, Chempoint TRO C, is at a concentration of approximately 2% of the pumpable slurry (e.g. water).

Next, at step 106 of method 100, a refrigeration pack housing may be provided. In some examples of method 100, the refrigeration pack housing may be flexible. In an example of method 100 wherein the refrigeration pack housing is flexible, it may be the case that the refrigeration pack that includes the pumpable slurry, the thickening agent and the refrigeration pack housing is also flexible. In some examples of method 100, the refrigeration pack housing may be a bag made of a plastic such as nylon, high-density polyethylene, low density polyethylene, or linear low-density polyethylene. In other examples, the refrigeration pack housing may be made of an alternative liquid retaining material. In yet another example of the method 100, the refrigeration pack housing may be a hard plastic container. In yet another example, the refrigeration pack housing may be a liner. In example where the refrigeration pack housing is a liner, the liner may be attachable to an interior surface of a storage container. For example, the liner may attach to a sidewall of the storage container. In other examples, the refrigeration pack housing may be integrally formed with a storage container.

Still referring to FIG. 1, at step 108 the pumpable slurry may be provided to the refrigeration pack housing. In some examples of method 100, proving the pumpable slurry may include using a nozzle to direct the pumpable slurry into the refrigeration pack housing. In some examples, the refrigeration pack housing may be submerged in a vat of the pumpable slurry and removed such that a portion of the pumpable slurry is contained within the refrigerant pack housing.

In some examples of method 100, the step 104 of providing the thickening agent may comprise providing the thickening agent to the refrigeration pack housing. In some examples, the thickening agent may be provided by coating the inside walls of the refrigeration pack housing with the thickening agent. At step 108, when the pumpable slurry is provided to the refrigeration pack housing, the pumpable slurry will contact the thickening agent present within the refrigeration pack housing. The liquid component of the pumpable slurry and the thickening agent may form a solution, such that the thickening agent is incorporated within the liquid component of the pumpable slurry. In other examples, the thickening agent may be provided to the refrigeration pack housing at the same time as the pumpable slurry is provided to the refrigeration pack housing. In other examples, the thickening agent may be provided to the refrigeration pack housing after the pumpable slurry is provided to the refrigeration pack housing.

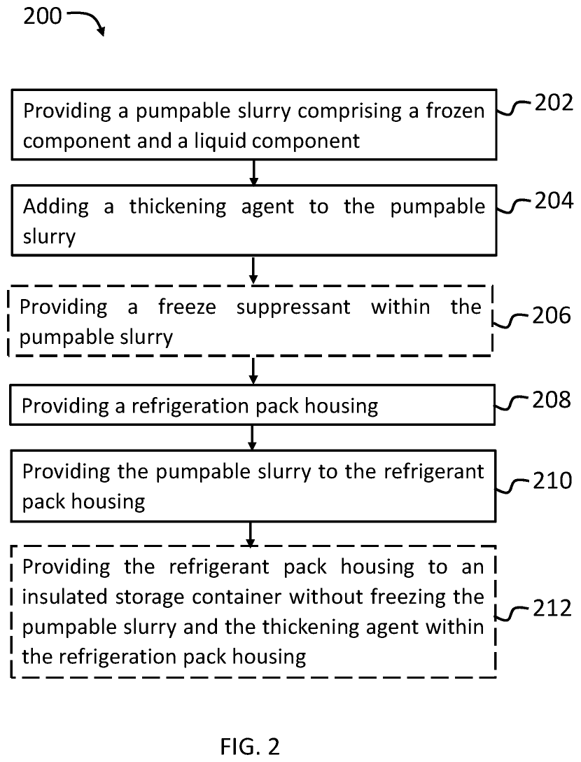

Referring now to FIG. 2, shown therein is an alternative method of providing a refrigeration pack. Steps 202, 204, 208 and 210 of method 200 correspond to steps 102, 104, 106, and 108 of method 100 respectively. Accordingly, the description that follows may be applicable to method 100. Moreover, the description above in reference to FIG. 1 may also apply to the method described by FIG. 2.

As shown in FIG. 2, in a method of providing a refrigeration pack 200, the method may include a step, step 206, which includes providing a freeze suppressant within the pumpable slurry. In some examples, the freeze suppressant may be provided to a fluid before it is converted to a pumpable slurry. When the fluid to be converted to a pumpable slurry is first provided with a freeze suppressant before being converted to a slurry, the slurry formed from the fluid may comprise smaller frozen component crystals than if the freeze suppressant was added after the formation of the slurry. In other examples, the freeze suppressant may be added to the pumpable slurry when it is in slurry form. As shown in method 200, the freeze suppressant may be added to the pumpable slurry after the thickening agent has been added to the pumpable slurry. In other embodiments, the freeze suppressant may be added to the pumpable slurry before the thickening agent is added to the pumpable slurry. In yet another embodiment, the thickening agent and the freeze suppressant may be added to the pumpable slurry simultaneously.

A freeze suppressant may be added to the pumpable slurry to reduce the freezing temperature of the pumpable slurry to a temperature below 0° C. In some examples of method 200, the freeze suppressant may be at least one ethylene glycol or propylene glycol.

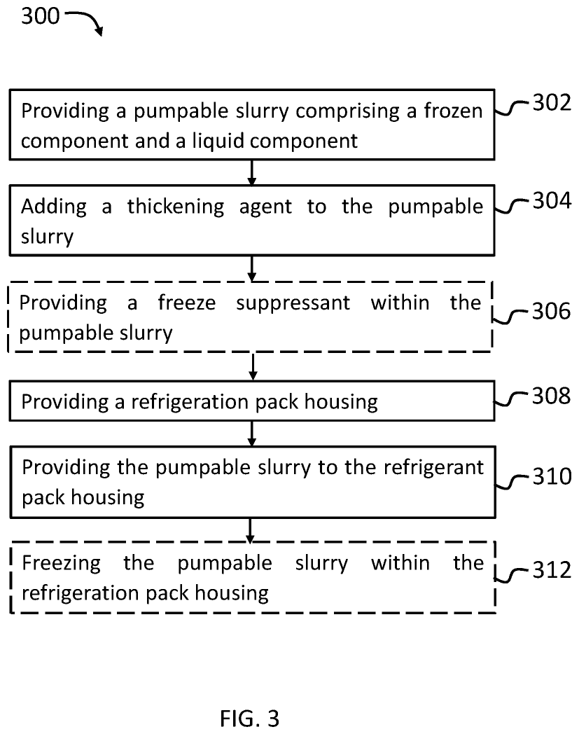

Still referring to FIG. 2, in some examples of method 200, after the pumpable slurry has been provided to the refrigeration pack housing thereby forming a refrigeration pack, the refrigeration pack may be provided to an insulated container, step 212. In some examples, the pumpable slurry and the thickening agent may not be frozen within the refrigeration pack housing when the refrigerant pack is provided to the insulated container. In other examples, see for e.g. FIG. 3 (and especially in step 312), in some examples of a method of providing a refrigerant pack, the pumpable slurry may be frozen within the refrigeration pack housing. In this example, the refrigeration pack with the frozen pumpable slurry may be provided to an insulated storage container.

In some embodiments, the refrigeration pack may be multiple refrigeration packs for including within the insulated storage container, and at least some of these multiple refrigeration packs may be liners for attaching to an interior of the insulated storage container. For example, some liners may attach to a sidewall of the storage container so that the sidewall of the storage container holds the refrigeration pack in place. In other examples, one or more liners may be integrally formed with the storage container.

Steps 302, 304, 306, 308, and 310 of method 300 correspond to steps 202, 204, 206, 208, and 210 of method 200 respectively. Accordingly, the description that above may be applicable to method 100. Moreover, the description above in reference to FIG. 1 may also apply to the method described by FIG. 3.

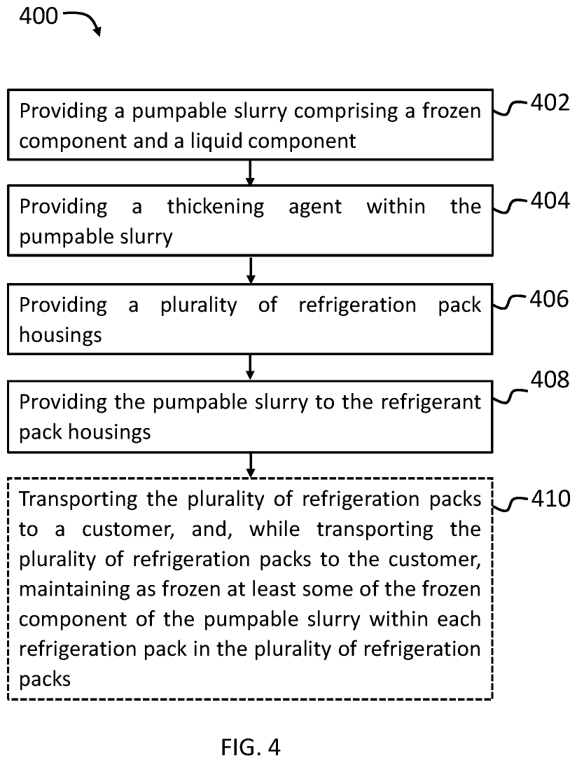

Referring now to FIG. 4, shown therein is an alternate method 400 of providing a plurality of refrigeration packs. Steps 402, 404, 406 and 408 correspond to steps 102, 104, 106 and 108 of method 100 respectively Steps 402, 404, 406 and 408 differ from steps 102, 104, 106 and 108 of method 100 only in that method 400 provides a plurality of refrigeration packs. The description above in reference to FIG. 1 may also apply to the method described by FIG. 4 for providing a plurality of refrigeration packs.

At step 410 of method 400, a plurality of refrigeration packs are transported to a customer. During transportation, the refrigeration packs are handled in a manner such that at least a portion of the frozen component of the pumpable slurry is maintained. This may be achieved by storing the plurality of refrigeration packs in an insulated environment, such as a cooler, or an extruded polystyrene container to reduce heat transfer from the environment to the plurality of refrigeration packs. In other examples of method 400, refrigeration packs may be transported in a refrigerated container. The refrigerated container may be maintained at or below the freezing temperature of the pumpable slurry. In other examples, the refrigerated container may be maintained at a temperature above the freezing temperature of the pumpable slurry, but below the ambient temperature.

By handling the plurality of refrigeration packs in such a manner, the refrigeration packs may be received by the customer such that the pumpable slurry within the refrigeration packs retains the frozen component. When the customer receives the refrigeration packs containing a partially frozen slurry, the customer may immediately use the refrigeration packs for cooling purposes. The refrigeration packs may provide a greater rate of heat transfer when containing a partially frozen slurry than when frozen solid. Alternatively, the customer may freeze the plurality of refrigeration packs solid. By providing the refrigeration packs in a condition wherein the pumpable slurry is partially frozen, the customer may freeze the refrigeration packs solid using less energy and in less time.

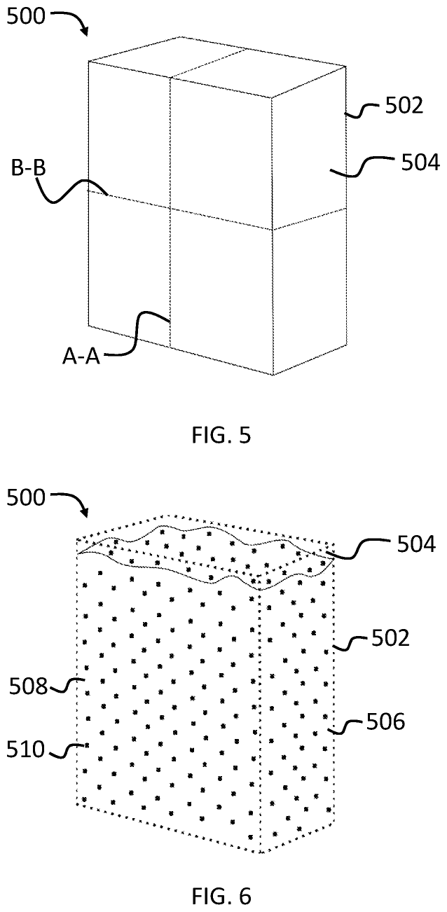

Referring now to FIG. 5, pictured therein is a refrigeration pack 500. The refrigeration pack 500 comprises a refrigeration pack housing 502, defining an internal volume 504. In the example refrigeration pack 500 of FIG. 5, the refrigeration pack housing 502 and internal volume 504 are in the form of a rectangular prism. In other examples, the refrigeration pack housing 502 and internal volume 504 may take on different forms, including, but not limited to: rounded rectangular prisms, cylinders, spheres, and irregular volumes. Different shapes may provide different heat transfer characteristics. For example, a spherical form of housing may have the smallest possible surface area to volume ratio. This may result in reduced rate of heat transfer from the environment to the refrigeration pack, and therefore, may allow the refrigeration pack to remain at a low temperature for a longer period of time. Other forms may have greater surface area to volume ratios, resulting in a greater rate of heat transfer from the refrigeration pack to the environment or the environment to the refrigeration pack.

Referring now to FIG. 6, pictured therein is a transparent view of refrigeration pack 500. Within internal volume 504 is a pumpable slurry 506. The pumpable slurry 506 comprises a liquid component 508 and a frozen component 510. In some examples, the liquid component 508 may be water, and the frozen component 510 may be ice.

In some examples of refrigeration pack 500, the refrigeration pack housing 502 may be flexible. In an example of refrigeration pack 500 wherein the refrigeration pack housing 502 is flexible, it may be the case that the refrigeration pack 500 that includes the pumpable slurry 506, the thickening agent and the refrigeration pack housing 502 is also flexible. In some examples of refrigeration pack 500, the refrigeration pack housing 502 may be a bag made of a plastic such as nylon, high-density polyethylene, low density polyethylene, or linear low-density polyethylene. In other examples, the refrigeration pack housing 502 may be made of an alternative liquid retaining material. In yet other examples of the refrigeration pack 500, the refrigeration pack housing 502 may be a hard plastic container. In yet another example, the refrigeration pack housing 502 may be a liner. In embodiments where the refrigeration pack housing 502 is a liner, the liner may be attachable to an interior surface of a storage container. For example, the liner may attach to a sidewall of the storage container. In other examples, the refrigeration pack housing 502 may be integrally formed with a storage container.

In some examples, the pumpable slurry 506 further comprises a thickening agent. When added to the pumpable slurry 506, the thickening agent may increase the viscosity of the pumpable slurry 506. In some examples, the thickening agent may increase the viscosity of the pumpable slurry 506 by sorbing a portion of the liquid component 508 of the pumpable slurry. In some examples, the pumpable slurry 506 may be provided, then the thickening agent may be added to at least the liquid component 508 of the pumpable slurry, such that the thickening agent is present largely only in the liquid component 508 of the pumpable slurry. In other examples of refrigeration pack 500, the thickening agent may be provided to a fluid before it is converted to a pumpable slurry 506, such that the concentration of the thickening agent in the liquid portion 508 is substantially equal to the concentration of the thickening agent in the frozen component 510. In some examples, the thickening agent may be cornstarch. In other examples, the thickening agent may be gelatin.

In some examples of refrigeration pack 500, the thickening agent may be a polymer. When added to the pumpable slurry 506, the polymer may absorb some of the liquid component 508 of the pumpable slurry 506 and may thereby increase a viscosity of the pumpable slurry 506. In some examples of refrigeration pack 500, the polymer may be an anionic water-soluble cellulosic polymer. An anionic water-soluble cellulosic polymer may provide a viscosity of 60000 cP. In some examples, highly viscous solutions in the liquid component 508 may be produced by the addition of anionic water-soluble cellulosic polymer, salts, glycols, and optionally alcohols for frost protection. These polymers, salts, glycols and/or alcohols may, in combination, total up to or even exceed 50% of the total weight (most of the remaining weight being water and ice), depending on the desired viscosity. Cellulosic polymers may be used as they may be non-toxic, food contact approved and may have a green profile for medical and food-related uses. If necessary, in some examples, at least one of ethylene glycol, propylene glycol or salts like aluminum sulfates, calcium chloride, sodium chloride and small amounts of a water soluble organic dye may also be added to the pumpable slurry 506. In some examples of refrigeration pack 500, the polymer may be at least one of WALOCEL™ CRT and METHOCEL™, which are available from Dupont. In other example, the polymer may be WALOCEL™ CRT 60000 GA, which is a high viscosity sodium carboxymethyl cellulose also available from Dupont. In yet another example of refrigeration pack 500, the polymer may be sodium polyacrylate. Sodium polyacrylate may be used as a thickening agent due to its ability to absorb and hold onto water molecules. In some examples, wherein the added polymer is sodium polyacrylate, the sodium polyacrylate may be 2% by weight of the sodium polyacrylate and water solution, and the water may be 98% by weight of the sodium polyacrylate and water solution. In some examples of refrigeration pack 500, the polymer may be a super absorbent polymer. For example, in some examples of refrigeration pack 500, the super absorbent polymer may be Chempoint TRO C. In some examples, the thickening agent may absorb many times its weight of the liquid component 508 of the pumpable slurry 506. In some examples, the thickening agent may absorb at least 30 times the weight of the thickening agent of liquid component 508. In some examples, the thickening agent may absorb at least 50 times or even 300 times its weight of the liquid component of the pumpable slurry.

Adding the thickening agent may increase viscosity even when the pumpable slurry 506 is entirely melted. In this melted state without the thickening agent, viscosity might otherwise be much reduced (viscosity will typically be increased by the presence of the frozen component in the pumpable slurry). However, adding the thickening agent can maintain viscosity even in this melted state. In some examples, when the frozen component 510 of the pumpable slurry is entirely melted, the viscosity of the pumpable slurry is a minimum of 20000 cP. In some embodiments in which the pumpable slurry is a combination of ice and water, the ice pack viscosity can range between 20,000 to 60,000 cP, and may have an average viscosity of 30,000 cP when the thickening agent, the super absorbent polymer, Chempoint TRO C, is at a concentration of approximately 2% of the slurry.

In some examples of refrigeration pack 500, a freeze suppressant may be provided within the pumpable slurry 506. A freeze suppressant may be provided within the pumpable slurry 506 to reduce the freezing temperature of the pumpable slurry to a temperature below 0° C. In some examples, the freeze suppressant may be at least one ethylene glycol or propylene glycol.

In some examples, the freeze suppressant may be provided to a fluid before it is converted to a pumpable slurry 506. When the fluid to be converted to a pumpable slurry 506 is first provided with a freeze suppressant before being converted to a slurry, the slurry formed from the fluid may comprise smaller frozen component crystals than if the freeze suppressant was added after the formation of the slurry. In other examples, the freeze suppressant may be added to the pumpable slurry 506 when it is in slurry form.

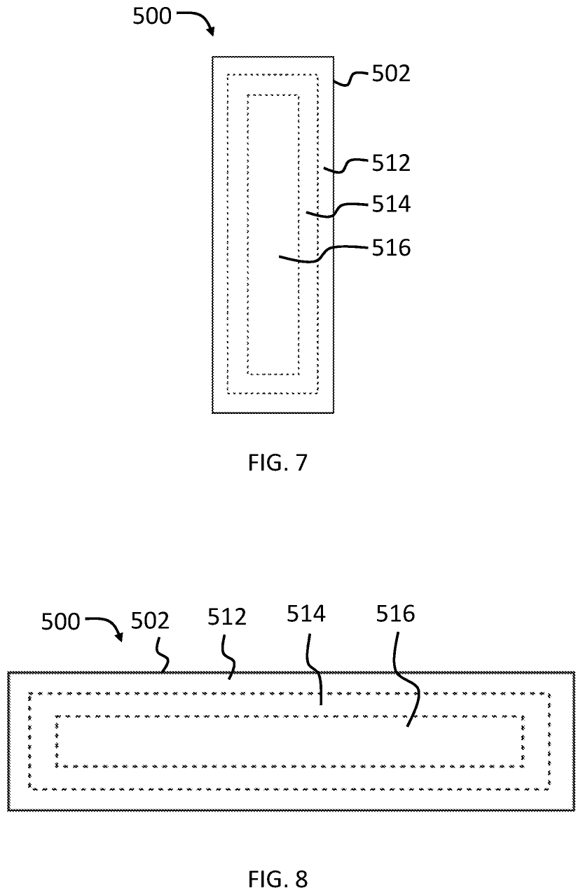

Referring now to FIGS. 7 and 8, pictured therein is a cross sectional profile and plan view of refrigeration pack 500, along section A-A of FIG. 5 and B-B of FIG. 5 respectively. As shown, internal volume 504 is divisible into thirds. A peripheral portion 512, occupies the outermost third of internal volume 504, along the periphery of refrigeration pack housing 502. Adjacent to peripheral portion 512, an intermediate portion 514 occupies ⅓ of the internal volume 504. Adjacent to the intermediate portion 514, occupying the innermost third of the internal volume 504 is a core portion 516.

In other examples, wherein the refrigeration pack housing 502 differs in shape, the peripheral portion 512, intermediate portion 514 and core portion 516 may differ in shape. In other examples wherein the refrigeration pack housing 502 is an irregular shape, the peripheral portion 512, intermediate portion 514 and core portion 516 may be irregularly shaped.

A ratio of the frozen component 510 to the liquid component 508 of the pumpable slurry 506 of the peripheral portion 512 is defined as the peripheral ratio. A ratio of the frozen component 510 to the liquid component 508 of the pumpable slurry 506 of the intermediate portion 514 is defined as the intermediate ratio. A ratio of the frozen component 510 to the liquid component 508 of the pumpable slurry 506 of the core portion 516 is defined as the core ratio. In an example refrigeration pack 500, the peripheral ratio, intermediate ratio and core ratio are all substantially the same. Across the internal volume 504 of refrigeration pack 500, the ratio of the frozen component 510 to the liquid component 508 of the pumpable slurry 506 can be substantially constant, at least when, or shortly after, the refrigeration pack housing 502 has been filled with the pumpable slurry 506, as the ratio of the frozen component 510 to the liquid component 508 of the feed pumpable slurry 506, upstream of the refrigeration pack housing 502, is substantially constant.

A ratio of the frozen component 510 to the liquid component 508 of the pumpable slurry 506 of the entirety of internal volume 504 is defined as the average ratio. In some examples of refrigeration pack 500, the core ratio, intermediate ratio, and peripheral ratio are each within 2% of the average ratio, at least when, or shortly after, the refrigeration pack housing 502 has been filled with the pumpable slurry 506. In some examples of refrigeration pack 500, the core ratio, intermediate ratio, and peripheral ratio are each within 5% of the average ratio, at least when, or shortly after, the refrigeration pack housing 502 has been filled with the pumpable slurry 506.

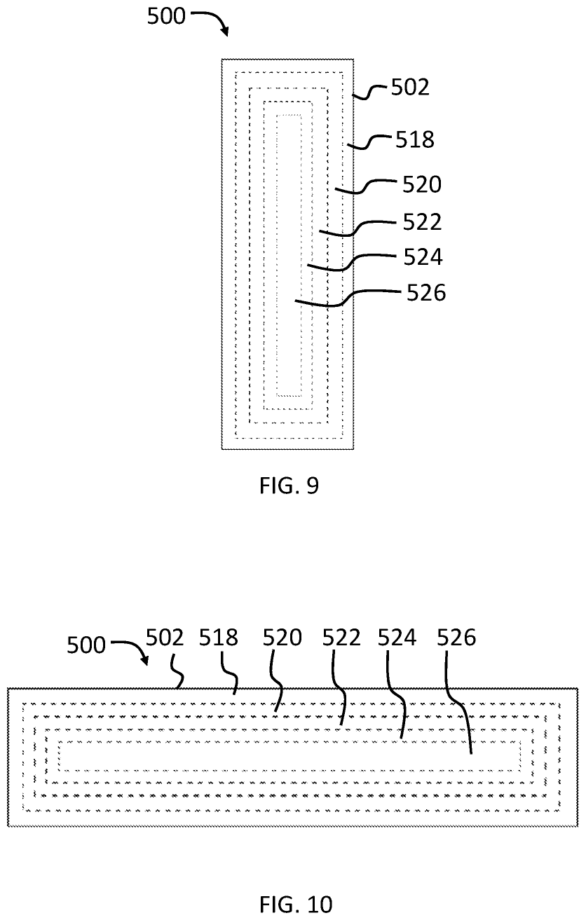

Referring now to FIGS. 9 and 10, pictured therein is a cross sectional profile and plan view of refrigeration pack 500, along section A-A of FIG. 5 and B-B of FIG. 5 respectively. The internal volume 504, a combination of the peripheral portion 512, intermediate portion 514 and core portion 516 may be divided into 5 equal volumes. The innermost portion is defined as the innermost first portion 526, comprising ⅕ of the internal volume 504. Adjacent to and wrapping around the innermost first portion 526 is the second portion 524, comprising ⅕ of the internal volume 504. Adjacent to and wrapping around the second portion 524 is the third portion 522, comprising ⅕ of the internal volume 504. Adjacent to and wrapping around the third portion 522 is the fourth portion 520, comprising ⅕ of the internal volume 504. Adjacent to both the refrigerator pack housing 502, and the fourth portion 520, and wrapping around the fourth portion 520 is the outermost fifth portion 518, comprising ⅕ of the internal volume 504.

In other examples, wherein the refrigerator pack housing 502 differs in shape, the innermost first portion 526, second portion 524, third portion 522, fourth portion 520 and outermost fifth portion 518 may differ in shape. In other examples wherein the refrigerator pack housing 502 is an irregular shape, the innermost first portion 526, second portion 524, third portion 522, fourth portion 520 and outermost fifth portion 518 may be irregularly shaped.

A ratio of the frozen component 510 to the liquid component 508 of the pumpable slurry 506 of the innermost first portion 526 is defined as the first ratio. A ratio of the frozen component 510 to the liquid component 508 of the pumpable slurry 506 of the second portion 524 is defined as the second ratio. A ratio of the frozen component 510 to the liquid component 508 of the pumpable slurry 506 of the third portion 522 is defined as the third ratio. A ratio of the frozen component 510 to the liquid component 508 of the pumpable slurry 506 of the fourth portion 520 is defined as the fourth ratio. A ratio of the frozen component 510 to the liquid component 508 of the pumpable slurry 506 of the outermost fifth portion 518 is defined as the fifth ratio. In some examples of refrigeration pack 500, the first ratio, second ratio, third ratio, fourth ratio and fifth ratio are each within 5% of the average ratio.

Once a refrigeration pack 500 is prepared, it may be handled in a manner that promotes the maintenance of the average ratio. This handling may include storing the refrigeration pack 500 within an insulated container such as a cooler or extruded polystyrene container to minimize heat transfer into the refrigeration pack 500. In other examples, this handling may include storing the refrigeration pack 500 in a refrigerated environment at a temperature at or below the freezing temperature of pumpable slurry 506. In other examples, this handling may include storing the refrigeration pack 500 in a refrigerated environment at a temperature above the freezing temperature of pumpable slurry 506, but below the ambient temperature.

Optionally, the refrigeration pack 500 may be cooled, such that the entirety of the pumpable slurry 506 is fully frozen. Depending on the composition of the pumpable slurry 506, different temperatures may be required to fully freeze the pumpable slurry 506. In some examples, pumpable slurry 506 comprises water, and the thickening agent used may have little to no effect on the freezing temperature of the pumpable slurry 506. In such an example, the refrigeration pack 500 may freeze at approximately 0° C. In other examples, the pumpable slurry 506 may further comprise a freeze suppressant, or the thickening agent used may have a freezing suppressant effect. As a result, the refrigeration pack 500 may have to be cooled to a temperature below 0° C. to fully freeze the pumpable slurry 506.

Prepared refrigeration pack 500 may be provided to a customer such that the average ratio is maintained, as described in the paragraph above. By handling the refrigeration pack 500 in such a manner, the refrigeration pack 500 may be received by the customer such that the pumpable slurry 506 within the refrigeration pack 500 retains the frozen component 510. When the customer receives the refrigeration pack 500 with a partially frozen pumpable slurry 506, the customer may immediately use the refrigeration pack 500 for cooling purposes. The refrigeration pack 500 may provide a greater rate of heat transfer when containing a partially frozen pumpable slurry 506 than when frozen solid. Alternatively, the customer may freeze the refrigeration pack 500 solid. By providing the refrigeration pack 500 in a condition wherein the pumpable slurry 506 is partially frozen, the customer may freeze the refrigeration pack 500 solid using less energy and in less time.

The present invention has been described here by way of example only. Various modification and variations may be made to these exemplary embodiments without departing from the spirit and scope of the invention, which is limited only by the appended claims.

We claim:

1. A method of making a refrigeration pack, the method comprising
a) providing a pumpable slurry comprising a frozen component and a liquid component,
b) providing within the pumpable slurry a thickening agent to absorb some of the liquid component of the pumpable slurry, and to increase a viscosity of the pumpable slurry;
c) providing a refrigeration pack housing; and,
d) providing the pumpable slurry to the refrigeration pack housing.

2. The method as defined in claim 1 wherein the refrigeration pack housing is flexible, such that the refrigeration pack comprising the pumpable slurry, the thickening agent and the refrigeration pack housing is flexible.

3. The method as defined in claim 1 further comprising providing the refrigeration pack to an insulated storage container without freezing the pumpable slurry and the thickening agent within the refrigeration pack housing.

4. The method as defined in claim 1 further comprising providing a freeze suppressant within the pumpable slurry to reduce the freezing temperature of the pumpable slurry below 0° C.

5. The method as defined in claim 4 wherein the freeze suppressant comprises at least one of ethylene glycol or propylene glycol.

6. The method as defined in claim 1 wherein the thickening agent is one of a polymer, cornstarch or gelatin.

7. The method as defined in claim 1 wherein the thickening agent is a polymer.

8. The method as defined in claim 7 wherein the polymer is a super absorbent polymer.

9. The method as defined in claim 1 further comprising freezing the pumpable slurry within the refrigeration pack housing.

10. The method as defined in claim 1 wherein providing the thickening agent within the pumpable slurry comprises first providing the frozen component and the liquid component, and then adding the thickening agent to at least the liquid component of the pumpable slurry.

11. The method as defined in claim 10 wherein the frozen component is ice and the liquid component is water, and providing the frozen component and the liquid component comprises cooling water to its freezing temperature.

12. The method as defined in claim 10 wherein even when the frozen component is entirely melted, the viscosity of the pumpable slurry is a minimum of 20,000 cP.

13. The method as defined in claim 1 wherein providing the thickening agent within the pumpable slurry comprises providing the thickening agent to the refrigeration pack housing.

14. The method as defined in claim 1 wherein a weight of the liquid component of at least 30 times the weight of the thickening agent is absorbable by the thickening agent.

15. A method of providing a plurality of refrigeration packs wherein each refrigeration pack in the plurality of refrigeration packs is made as defined in claim 1, the method further comprising transporting the plurality of refrigeration packs to a customer, and, while transporting the plurality of refrigeration packs to the customer, maintaining as frozen at least some of the frozen component of the pumpable slurry within each refrigeration pack in the plurality of refrigeration packs.

16. A refrigeration pack comprising
a refrigeration pack housing defining an internal volume divisible into a core portion, comprising ⅓ of the internal volume, a peripheral portion comprising ⅓ of the internal volume, and an intermediate portion between the core and peripheral portions comprising ⅓ of the internal volume;
a pumpable slurry within the refrigeration pack housing, wherein
the pumpable slurry comprises a frozen component and a liquid component;
the pumpable slurry has a core ratio of the frozen component to the liquid component within the core portion;
the pumpable slurry has an intermediate ratio of the frozen component to the liquid component within the intermediate portion;
the pumpable slurry has a peripheral ratio of the frozen component to the liquid component within the peripheral portion; and,
the core ratio, the intermediate ratio and the peripheral ratio are substantially the same.

17. The refrigeration pack as defined in claim 16 further comprising a thickening agent for absorbing some of the liquid component of the slurry to increase the viscosity of the slurry.

18. The refrigeration pack as defined in claim 17 wherein the thickening agent is a polymer.

19. The refrigeration pack as defined in claim 18 wherein the polymer is a super absorbent polymer.

20. The refrigeration pack as defined in claim 16 wherein a weight of the liquid component of at least 30 times the weight of the thickening agent is absorbable by the thickening agent.

21. The refrigeration pack as defined in claim 16 wherein
the internal volume of the refrigeration pack housing has an average ratio of the frozen component to the liquid component; and,
the core ratio, the intermediate ratio and the peripheral ratio are each within 5% of the average ratio of the frozen component to the liquid component.

22. The refrigeration pack as defined in claim 16 wherein
the internal volume of the refrigeration pack housing has an average ratio of the frozen component to the liquid component; and,
the core ratio, the intermediate ratio and the peripheral ratio are each within 2% of the average ratio of the frozen component to the liquid component.

23. The refrigeration pack as defined in claim 16 wherein
the internal volume, and a combination of the core portion, intermediate portion and peripheral portion are divisible into an innermost first portion comprising ⅕ of the internal volume, a second portion adjacent the innermost first portion comprising ⅕ of the internal volume, a third portion adjacent the second portion comprising ⅕ of the internal volume, a fourth portion adjacent the third portion comprising ⅕ of the internal volume, and an outermost fifth portion adjacent the fourth portion comprising ⅕ of the internal volume;
the pumpable slurry has a first ratio of the frozen component to the liquid component within the innermost first portion;
the pumpable slurry has a second ratio of the frozen component to the liquid component within the second portion;
the pumpable slurry has a third ratio of the frozen component to the liquid component within the third portion;
the pumpable slurry has a fourth ratio of the frozen component to the liquid component within the fourth portion;
the pumpable slurry has a fifth ratio of the frozen component to the liquid component within the outermost fifth portion;
the internal volume of the refrigeration pack housing has an average ratio of the frozen component to the liquid component; and,
the first ratio, the second ratio, the third ratio, the fourth operation and the fifth ratio are each within 5% of the average ratio of the frozen component to the liquid component.
